(19) United States
(12) Patent Application Publication
(10) Pub. No.: US 2001/0042003 A1
(43) Pub. Date: Nov. 15, 2001

(54) Network marketing business method

(75) Inventor: Kazuyoshi Tanaka, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/847,701

(22) Filed: May 2, 2001

(30) Foreign Application Priority Data
May 8, 2000 (JP) 2000-134419

(51) Int. Cl. G06F 17/60

(52) U.S. Cl. 705/10

(57) ABSTRACT

A network marketing business method, comprising steps of: placing sample data on colors, shapes, and sizes of products that may satisfy market needs on a home page of a server connected through a network before a company produces and sells the products (as a first step); and developing the products having the colors, the shapes, the sizes corresponding to access frequencies thereof on the home page accessed with browsing software of personal computers of customers through the network and selling the developed products on the market (as a second step). The second step may be performed by developing the products having the colors, the shapes, and the sizes corresponding to the access frequencies for each age, each residential area, and each sex type of the customers and selling the developed products on the market.

### BACKGROUND OF THE INVENTION

1. Field of the Invention

The present invention relates to a network marketing business method for placing, on a home page of a network such as the Internet, the marketing information on products probably required in the market of a company, before developing and selling the products corresponding to frequencies of access to the home page or creating a database and selling the created database to related companies.

2. Description of the Prior Art

Conventionally, when a company develops products, the company determines the colors, shapes, and sizes of the products corresponding to the replies of questionnaires collected from a limited number of sampled people and customers who bought its products.

However, in this method, the company cannot accurately obtain the needs of the target market. Thus, the company tends to self-satisfactorily develop products.

As a marketing business method using a home page of the Internet, a customer selects a product having the desired color, shape, and so forth from a product list on the home page, and a company delivers the selected product to the customer.

In this method, since the company can not produce products having the selected colors and shapes before selling them. Thus, this method is not suitable for a cost-oriented business which requires mass production.

### SUMMARY OF THE INVENTION

The present invention has been made to overcome the disadvantages as mentioned above, and therefore, has an object to provide a network marking business method that allows products that satisfy market needs with a high probability to be produced, quickly sold on the market, and prevented from remaining unsold depending on models and that overcomes the cause of dull reaction against the market needs.

Another object of the present invention is to provide a network marketing business method that allows data on products that satisfy market needs with a high probability, data on remedies against overproduction, and data on remedies of dull reaction against the market needs to be obtained as highly valuable information that is sellable.

According to a first aspect of the present invention, there is provided a network marketing business method, comprising steps of: placing sample data on colors, shapes, and sizes of products that may satisfy market needs on a home page of a server connected through a network before a company produces and sells the products (as a first step); and developing the products having the colors, the shapes, the sizes corresponding to access frequencies thereof on the home page accessed with browsing software of personal computers of customers through the network and selling the developed products on the market (as a second step).

Thus, sample data on colors, shapes, and sizes of products that may satisfy the market needs is placed on a home page of a server connected through a network before a company produces and sells products. The products having the colors, the shapes, the sizes, and so forth are produced corresponding to access frequencies thereof on the home page accessed with browsing software of personal computers of customers through the network. The developed products are sold on the market. Thus, the products can be adaptively sold. In addition, the overproduction depending on models and the dull reaction against the market needs can be prevented.

According to a second aspect of the present invention, there is provided a network marketing business method, comprising steps of: transmitting sample data on colors, shapes, and sizes of products that may satisfy market needs from a server to personal computers of customers as electronic mails through a network before a company produces and sells the products (as a first step); and developing products having the colors, the shapes, and the sizes corresponding to selected frequencies thereof in replies from the customers as recipients of the electronic mails and selling the products on the market (as a second step).

Thus, sample data on colors, shapes, and sizes of products that may satisfy the market needs is transmitted from a server to personal computers of customers as electronic mails through a network before a company produces and sells products. Products having the colors, the shapes, and the sizes are developed corresponding to selected frequencies in replies from the customers as recipients of the electronic mails. The products are sold on the market. Thus, the products that satisfy the market needs with a high probability can be produced. In addition, the products can be adaptively sold. Moreover, the overproduction depending on models and the dull reaction against the market needs can be prevented.

According to a third aspect of the present invention, there is provided a network marketing business method, comprising steps of: placing sample data on colors, shapes, and sizes of products that may satisfy market needs on a home page of a server connected through a network before a company produces and sells the products (as a first step); and creating a database containing colors, shapes, and sizes corresponding to access frequencies thereof on the home page accessed with browsing software of personal computers of customers through the network and selling the created database to the company (as a second step).

Thus, sample data on colors, shapes, and sizes of products that may satisfy the market needs is placed on a home page of a server connected through a network before a company produces and sells products. A database containing colors, shapes, and sizes is created corresponding to the access frequencies thereof on the home page accessed with browsing software of personal computers of customers through the network. The created database is sold to the company. Thus, data of products that satisfy market needs with a high probability, data of remedies against overproduction, and data of remedies of dull reaction against the market needs can be obtained as highly valuable information that is sellable.

According to a fourth aspect of the present invention, there is provided a network marketing business method, comprising steps of: transmitting sample data on colors, shapes, and sizes of products that may satisfy market needs from a server to personal computers of customers as electronic mails through a network before a company produces and sells the products (as a first step); and creating a database containing colors, shapes, and sizes corresponding to selected frequencies thereof in replies from the customers as the recipients of the electronic mails and selling the created database to the company (as a second step).

Thus, sample data on colors, shapes, and sizes of products that satisfy the market needs is transmitted from a server to personal computers of customers as electronic mail through a network before a company produces and sells products. A database containing colors, shapes, and sizes is created corresponding to selected frequencies in replies from the customers as the recipients of the electronic mails. The created database is sold to the company. Thus, data of products that satisfy market needs with a high probability, data of remedies against overproduction, and data of remedies of dull reaction against the market needs can be obtained as highly valuable information that is sellable.

These and other objects, features and advantages of the present invention will become more apparent in light of the following detailed description of the best mode embodiment thereof, as illustrated in the accompanying drawings.

### BRIEF DESCRIPTION OF DRAWINGS

FIG. 1 is a block diagram showing the structure of an electronic commerce system using a network marketing business method according to an embodiment of the present invention;

FIG. 2 is a schematic diagram showing an example of collected data store in database according to the first embodiment of the present invention; and

FIG. 3 is a schematic diagram for explaining an example of sellable data that is composed of the collected data and that is formed as data necessary for developing and selling products.

### DESCRIPTION OF PREFERRED EMBODIMENT

Next, with reference to the accompanying drawings, a network marketing business method according to an embodiment of the present invention will be described.

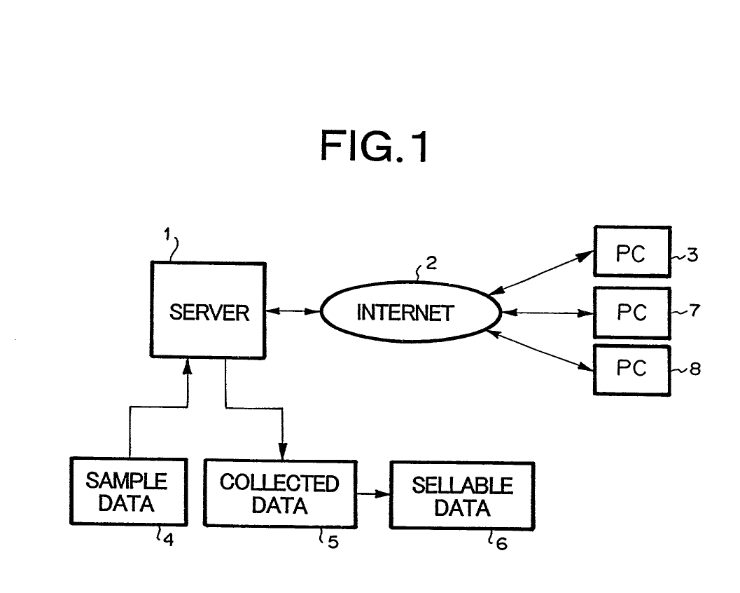

FIG. 1 is a block diagram showing the structure of an electronic commerce system using a network marketing business method according to an embodiment of the present invention.

In FIG. 1, a server 1 that stores home pages is connected to a wide area network such as the Internet 2.

The home pages contain information on products that a target market probably requires (in other words, sample data 4 such as colors, shapes, sizes, and so forth of the products).

Personal computers 3, 7, and 8 (hereinafter referred to as personal computers) used by many customers are connected to the Internet 2.

Each of the personal computers 3, 7, and 8 has browsing software that accesses the home page stored in the server 1.

The server 1 collects information on accesses from personal computers 3, 7, and 8 to the home pages to store collected data 5 in a database therein.

The server 1 also constructs sellable data 6 necessary for developing and selling products on the basis of the collected data and store the sellable data in another database therein.

Only three personal computers 3, 7, and 8 are shown in FIG. 1 for simplicity. In reality, however, a large number of personal computers are used.

The sample data 4 contains data in the form of picture and character representing functions, performances, and specifications of products that directly appeal to customers who may be users of the products.

If the function, performance, and specification of a product are visible, they are expressed by shape, color, and size in a picture

If the specifications of a product are the process speed, hardness, softness, quality assurance period, they are expressed by numerals and characters.

On the server 1, the sample data 4 are linked with home pages of the company concerned and with home pages of products which are targets of marketing. Therefore, the sample data 4 may be browsed on personal computers 3, 7, and 8.

Next, the operation of the electronic commerce system (shown in FIG. 1) using the network marketing business method according to the embodiment of the present invention will be described.

Each time a product in the sample data 4 is accessed from personal computer 3, 7, or 8, via link with home pages on the server 1, an access frequency of the category of the accessed product is increased in the collected data 5 in response to the access. In such a way, the access frequencies of respective categories of products are structured in the collected data.

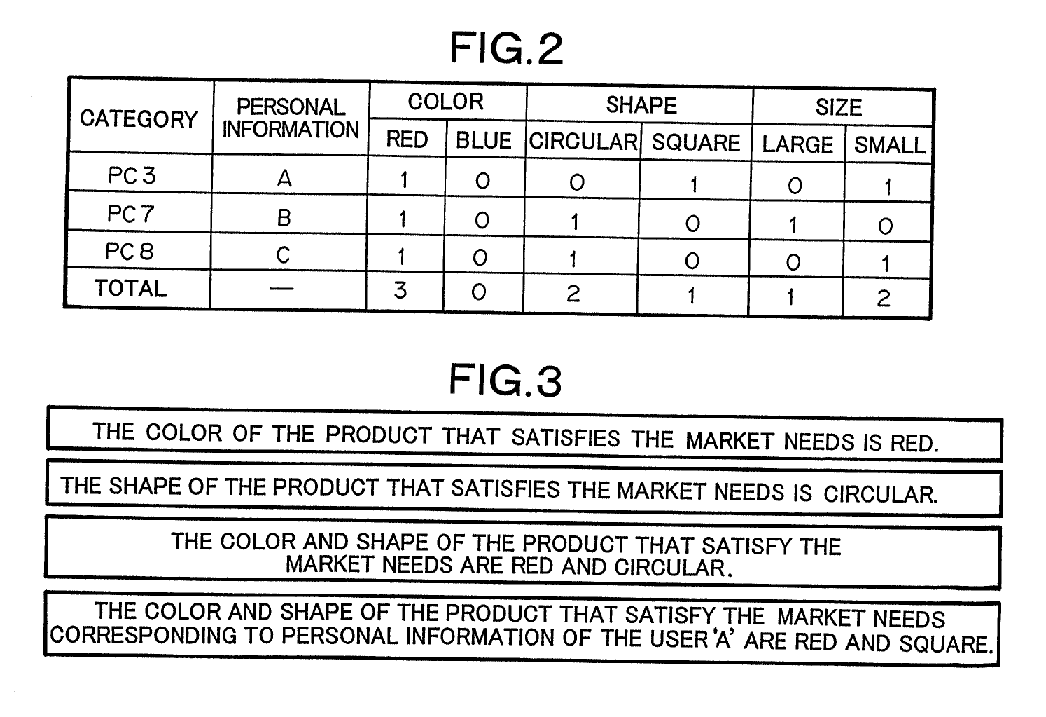

In the example shown in FIG. 2, the sample data 4 has three large categories, i.e., “color”, “shape”, and “size”.

Small categories belonging to the large category of “color” are “red” and “blue”. Small categories belonging to the large category of “shape” are “circular” and “square”. Small categories belonging to the large category of “size” are “large” and “small”.

When the users of the personal computers 3, 7, and 8 browse the home page, the access frequencies as shown in FIG. 2 are cumulated. As an example of the cumulated result, the frequencies of the small categories “red” and “blue” belonging to the large category “color” are “3” and “0”, respectively. The frequencies of the small categories “circular” and “square” belonging to the large category “shape” are “2” and “1”, respectively. The frequencies of the small categories “large” and “small” belonging to the large category “size” are “1” and “2”, respectively.

Personal information such as sex, age, and residential area of users of the personal computers 3, 7, and 8 is preregistered to the server 1. The personal information is linked to the columns (PC3, PC7, and PC8) of the personal computers 3, 7, and 8 shown in FIG. 2.

In FIG. 2, the personal information of the users of the personal computers 3, 7, and 8 is denoted by “A”, “B”, and “C”, respectively.

In reality, since a large number of personal computers are connected to the Internet 2, the cumulated values of access frequencies are huge.

Collected data shown in FIG. 2 is sold as sellable data 6 in various forms to companies concerned.

FIG. 3 shows an example of the sellable data 6 that is composed of the collected data and that is formed as data necessary for developing and selling products. FIG. 3 shows real examples of colors and shapes. In other words, “The color of the product that satisfies the market needs is red.”, “The shape of the product that satisfies the market needs is circular.”, “The color and shape of the product that satisfy the market needs are red and circular.”, and “The color and shape of the product that satisfy the market needs corresponding to the personal information of the user A are red and square.”.

The probability that the sellable data 6 predicts the preferences of the end users accurately is high. Thus, the products having the functions, appearances, and so forth reflecting the collected data can be adaptively placed on the market. Thus, the problems of overproduction depending on models and bad reaction against the market needs can be solved.

In addition, since the sellable data 6 is based on the market needs, it is highly valuable information data.

In other words, accurate market samples are obtained through the selection of the sample data 4 by users. In addition, the market scale is accurately estimated on the basis of the access frequencies.

Further, if the sample data 4 is linked to the popular home pages, the market research will be more accurate, and more effective marketing can be realized as compared to a case that each company independently performs the market research. In addition, since the colors, shapes, and sizes of products can be pre-designated corresponding to the preferences of the users and the quantity of the products can be controlled, the products can be developed and produced without the overproduction and regardless of whether they become popular.

As was described above, according to the network market business method of the present invention, sample data on colors, shapes, and sizes of products that may satisfy the market needs is placed on a home page of a server connected through a network before a company produces and sells products. The products having the colors, the shapes, the sizes, and so forth are produced corresponding to access frequencies thereof on the home page accessed with browsing software of personal computers of customers through the network. The developed products are sold on the market. Thus, the products can be adaptively sold. In addition, the overproduction depending on models and the dull reaction against the market needs can be prevented.

In addition, according to the network market business method of the present invention, sample data on colors, shapes, and sizes of products that may satisfy the market needs is transmitted from a server to personal computers of customers as electronic mails through a network before a company produces and sells products. Products having the colors, the shapes, and the sizes are developed corresponding to selected frequencies thereof in replies from the customers as recipients of the electronic mails. The products are sold on the market. Thus, the products that satisfy the market needs with a high probability can be produced. In addition, the products can be adaptively sold. Moreover, the overproduction depending on models and the dull reaction against the market needs can be prevented.

In addition, according to the network market business method of the present invention, sample data on colors, shapes, and sizes of products that may satisfy the market needs is placed on a home page of a server connected through a network before a company produces and sells products. A database containing colors, shapes, and sizes is created corresponding to the access frequencies thereof on the home page accessed with browsing software of personal computers of customers through the network. The created database is sold to companies concerned. Thus, data of products that satisfy market needs with a high probability, data of remedies against overproduction, and data of remedies of dull reaction against the market needs can be obtained as highly valuable information that is sellable.

In addition, according to the network market business method of the present invention, sample data about colors, shapes, and sizes of products that may satisfy the market needs is transmitted from a server to personal computers of customers as electronic mails through a network before a company produces and sells products. A database containing colors, shapes, and sizes is created corresponding to selected frequencies thereof from the customers as the recipients of the electronic mails. The created database is sold to companies concerned. Thus, data of products that satisfy market needs with a high probability, data of remedies against overproduction, and data of remedies of dull reaction against the market needs can be obtained as highly valuable information that is sellable.

Although the present invention has been shown and described with respect to the best mode embodiment thereof, it should be understood by those skilled in the art that the foregoing and various other changes, omissions, and additions in the form and detail thereof may be made therein without departing from the spirit and scope of the present invention.

What is claimed is:

1. A network marketing business method, comprising steps of:
placing sample data on colors, shapes, and sizes of products that may satisfy market needs on a home page of a server connected through a network before a company produces and sells the products (as a first step); and
developing the products having the colors, the shapes, the sizes corresponding to access frequencies thereof on the home page accessed with browsing software of personal computers of customers through the network and selling the developed products on the market (as a second step).

2. The network marketing business method as set forth in claim 1,
wherein the second step is performed by developing the products having the colors, the shapes, and the sizes corresponding to the access frequencies for each age, each residential area, and each sex type of the customers and selling the developed products on the market.

3. The network marketing business method as set forth in claim 1,
wherein the sample data contains numerals and characters that represent the process speed, hardness, softness, and quality assurance period as performance of the products.

4. A network marketing business method, comprising steps of:
transmitting sample data on colors, shapes, and sizes of products that may satisfy market needs from a server to personal computers of customers as electronic mails through a network before a company produces and sells the products (as a first step); and
developing products having the colors, the shapes, and the sizes corresponding to selected frequencies thereof in replies from the customers as recipients of the electronic mails and selling the products on the market (as a second step).

5. The network marketing business method as set forth in claim 4,
wherein the second step is performed by developing the products having the colors, the shapes, and the sizes corresponding to the selected frequencies for each age, each residential area, and each sex type of the customers and selling the developed products on the market.

6. The network marketing business method as set forth in claim 4,
wherein the sample data contains numerals and characters that represent the process speed, hardness, softness, quality and assurance period, as performance of the products.

7. A network marketing business method, comprising steps of:
placing sample data on colors, shapes, and sizes of products that may satisfy market needs on a home page of a server connected through a network before a company produces and sells the products (as a first step); and
creating a database containing colors, shapes, and sizes corresponding to access frequencies thereof on the home page accessed with browsing software of personal computers of customers through the network and selling the created database to the company (as a second step).

8. The network marketing business method as set forth in claim 7,
wherein the second step is performed by creating the database containing the colors, the shapes, and the sizes corresponding to the access frequencies for each age, each residential area, and each sex type of the customers and selling the created database to the companies.

9. The network marketing business method as set forth in claim 7,
wherein the sample data contains numerals and characters that represent the process speed, hardness, softness, and quality assurance period as performance of the products.

10. A network marketing business method, comprising steps of:
transmitting sample data on colors, shapes, and sizes of products that may satisfy market needs from a server to personal computers of customers as electronic mails through a network before a company produces and sells the products (as a first step); and
creating a database containing colors, shapes, and sizes corresponding to selected frequencies thereof in replies from the customers as the recipients of the electronic mails and selling the created database to the company (as a second step).

11. The network marketing business method as set forth in claim 10,
wherein the second step is performed by creating the database containing the colors, the shapes, and the sizes corresponding to the access frequencies for each age, each residential area, and each sex type of the customers and selling the created database to the company.

12. The network marketing business method as set forth in claim 10,
wherein the sample data contains numerals and characters that represent the process speed, hardness, softness, and quality assurance period as the performance of the products.
